(19) United States
(12) Patent Application Publication
(10) Pub. No.: US 2025/0272717 A1
(43) Pub. Date: Aug. 28, 2025

(54) SYSTEM AND METHOD FOR LOCATION-BASED INFORMATION DISTRIBUTION AND TRANSMISSION

(71) Applicant: Just Crossed Corporation, Tampa, FL (US)

(72) Inventor: Manny MANZEL, Tampa, FL (US)

(21) Appl. No.: 19/064,561

(22) Filed: Feb. 26, 2025

Related U.S. Application Data
(60) Provisional application No. 63/558,546, filed on Feb. 27, 2024.

(51) Int. Cl. G06Q 30/0251; G01C 21/00; G06Q 30/0273; H04L 51/222

(52) U.S. Cl. CPC G06Q 30/0261; G01C 21/3811; G06Q 30/0274; H04L 51/222

(57) ABSTRACT

Aspects of the present disclosure relate generally to systems and methods for location-based information distribution and transmission. An exemplary method is provided for transmitting data to a user based on a location and trajectory. The method includes receiving from a location determining device location information and trajectory information of a user; generating a geometric shape representing a physical region of interest based on the location information and a user trajectory of the user based on the trajectory information; selecting, by the server, a subset of information for display to the user responsive to (i) a present user context and (ii) the location information indicating the user trajectory will intersect the geometric shape representing the physical region of interest specified in the location information; and transmitting the subset of targeted information in an order of likely user proximity to the businesses within the geometric shape.

### CROSS REFERENCE TO RELATED APPLICATIONS

This application claims priority to U.S. Patent Provisional No. 63/558,546, filed Feb. 27, 2024, the entire contents of which are hereby incorporated by reference.

### TECHNICAL FIELD

Aspects of the present disclosure relate generally to systems and methods for generating and transmitting electronic information based on location and trajectory of a user, such as location-based mobile advertising.

### BACKGROUND

People paths may include being proximate to various business. Thus, there is a need for a way to enable people who are near a particular business to receive targeted advertisements relating to the particular business and the user's interests.

### SUMMARY

The following presents a simplified summary of one or more aspects to provide a basic understanding of such aspects. This summary is not an extensive overview of all contemplated aspects and is intended to neither identify key or critical elements of all aspects nor delineate the scope of any or all aspects. Its sole purpose is to present some concepts of one or more aspects in a simplified form as a prelude to the more detailed description that is presented later.

According to an aspect, a method is provided for transmitting data to a user based on a location and trajectory. In this aspect, the method includes receiving from a location determining device, by a receiver of a server having one or more processors and a transmitter, location information and trajectory information of a user; generating a geometric shape representing a physical region of interest based on the location information and a user trajectory of the user based on the trajectory information; selecting, by the server, a subset of targeted advertisements from a set of advertisements for display to the user responsive to (i) a present user context and (ii) the location information indicating the user trajectory will intersect the geometric shape representing the physical region of interest specified in the location information, the subset of targeted advertisements corresponding to businesses within at least a portion the geometric shape and based on the present user context; and transmitting, by a transmitter of the server to a user device of the user, the subset of targeted advertisements in an order of likely user proximity to the businesses within the geometric shape.

According to another aspect, a system is provided for transmitting data to a user based on a location and trajectory. In this aspect, the system includes a receiver configured to receive location information and trajectory information of a user from a location determining device, one or more memories, individually or in combination, having instructions; one or more processors each coupled to at least one of the one or more memories and configurable/operable to execute the instructions to generate a geometric shape representing a physical region of interest based on the location information and a user trajectory of the user based on the trajectory information, and select a subset of targeted advertisements from a set of advertisements for display to the user responsive to (i) a present user context and (ii) the location information indicating the user trajectory will intersect the geometric shape representing the physical region of interest specified in the location information, the subset of targeted advertisements corresponding to businesses within at least a portion the geometric shape and based on the present user context; and a transmitter configured to transmit the subset of targeted advertisements in an order of likely user proximity to the businesses within the geometric shape.

To the accomplishment of the foregoing and related ends, the one or more aspects comprise the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

The disclosed aspects will hereinafter be described in conjunction with the appended drawings, provided to illustrate and not to limit the disclosed aspects, wherein like designations denote like elements, and in which.

FIG. 1 illustrates an example of a computer environment, in accordance with example aspects of this disclosure.

FIG. 2 illustrates an example environment to which aspects of the present disclosure can be applied, in accordance with an example aspects of this disclosure.

FIG. 3 illustrates an example method for location-based mobile advertising, in accordance with example aspects of this disclosure\

FIGS. 4-6 illustrates further steps of the method of FIG. 3, in accordance with example aspects of this disclosure.

FIGS. 7-8 illustrates further steps of the method of FIG. 3 directed to different monetization models, in accordance with example aspects of this disclosure.

FIG. 9 illustrates an initial screen for a user subscription sign up, in accordance with example aspects of the present disclosure.

FIG. 10 illustrates a user and a user display with a map application using a path-based advertisement approach, in accordance with example aspects of the present disclosure.

FIG. 11 illustrates a user and a geofence, in accordance with example aspects of the present disclosure.

FIG. 12 illustrates a targeted advertisement from a subset of targeted advertisements, in accordance with example aspects of the present disclosure.

FIG. 13 illustrates a method for adjusting the geofence or proximity radius according to an exemplary aspect.

### DETAILED DESCRIPTION

Exemplary aspects of the present disclosure relate generally to systems and methods for generating and transmitting electronic information based on location and trajectory of a user, such as location-based mobile advertising.

In a world where personalized experiences are paramount, the proposed location-based mobile advertising service revolutionizes the way businesses connect with their target audience.

Leveraging the power of geolocation technology, the service will seamlessly integrate with in-application clients on mobile devices, presenting users with tailored offer feed based on their physical proximity to established advertising partners, all within an adjustable radius.

Exemplary aspects of the present disclosure may be performed in an actual physical environment and/or a virtual reality environment. The environments may overlap such that something that happens in one environments affects and/or otherwise also occurs in the second environment (e.g., likes, purchases, reviews, etc.).

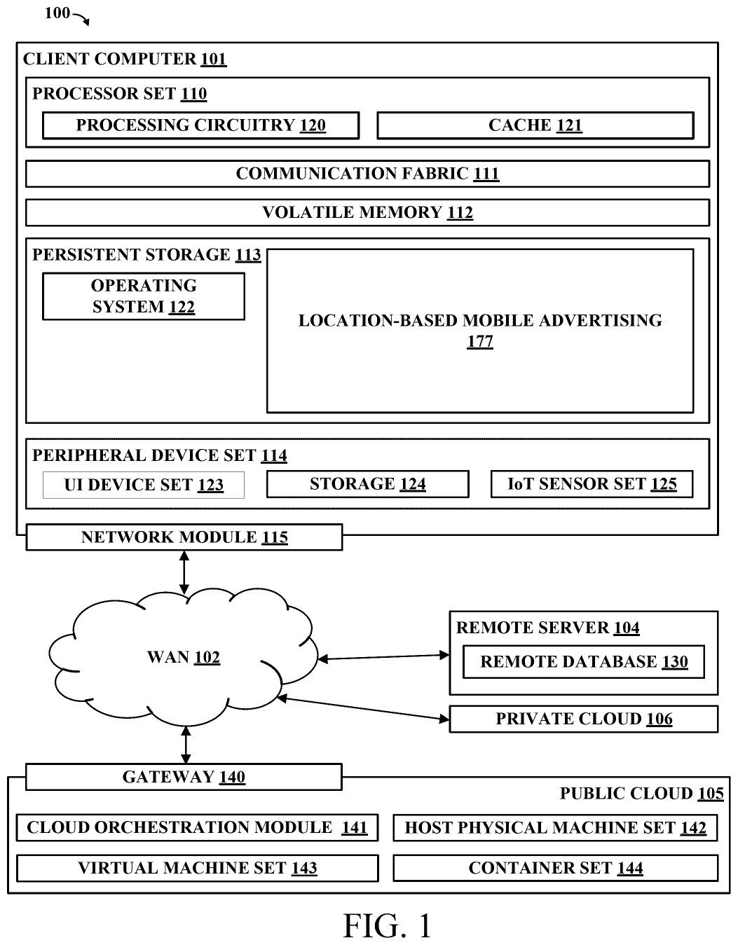

Referring to FIG. 1, an example computing environment 100 is shown, in accordance with example aspects of this disclosure.

Computing environment 100 includes an example of an environment for the execution of at least some of the computer code 177 involved in performing the inventive methods, such as location-based mobile advertising. In addition to block (computer code) 177, computing environment 100 includes, for example, computer 101, wide area network (WAN) 102, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 177, as identified above), peripheral device set 114 (including user interface (UI), device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 177 in persistent storage 113.

COMMUNICATION FABRIC 111 is the signal conduction paths that allow the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, the volatile memory is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface type operating systems that employ a kernel. The code included in block 177 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion type connections (for example, secure digital (SD) card), connections made though local area communication networks and even connections made through wide area networks such as the internet. In various embodiments, UI device set 123 may include components such as a display screen, speaker, microphone, wearable devices (such as goggles and smart watches), keyboard, mouse, printer, touchpad, virtual reality goggles, augmented reality goggles, mixed reality goggles, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) configured to communicate computer data over non-local distances by any technology for communicating computer data, now known or to be developed in the future. In some embodiments, the WAN may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Public cloud may provide a subscription service for people interaction to a plurality of users such as a user of computer 101. The service can have multiple purposes for people interaction. Such purposes for people interaction can include dating, friendship, and business.

In an aspect, public cloud 105 operates in conjunction with remote server 104 to enable profile information of users to be retrieved and provided to a user such as one using computer 101 and/or another user operating a similar device as computer 101.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

While remote server 104 is shown as a separate entity from private cloud 106 and public cloud 105, in other aspects, the server 104 may be located in private cloud 106 and/or public cloud 105. In an aspect, user profile information is stored in private cloud 106 and advertisements are stored in public cloud 105. In this way, the advertisements can be accessed irrespective of proximity to user location such as, for example, through a search engine over the Internet, while private information relating to a user's profile is securely stored in private cloud 106. However, it is envisioned that aspects of this disclosure will be used by the user is in motion in a location near businesses, such as on a single street with one or more businesses, a shopping mall with tens of businesses, and so forth.

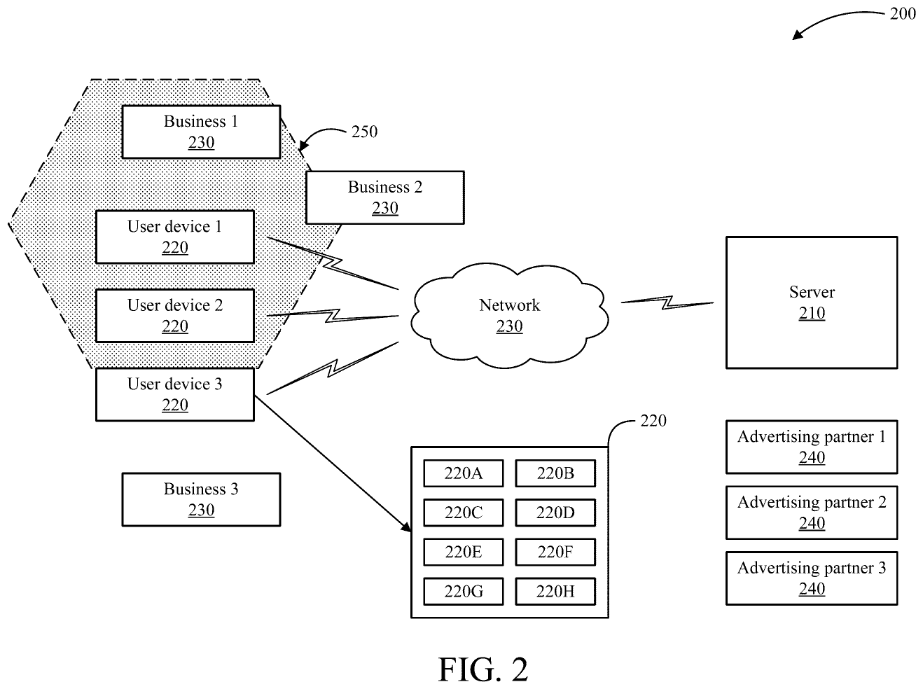

Referring to FIG. 2, an example environment 200 to which aspects of the present disclosure can be applied is shown, in accordance with example aspects of this disclosure. As shown, the environment 200 includes a server 210, a set of user devices (user device 1 through 3) 220, a set of businesses (businesses 1-3) 230, and a set of advertising partners (advertising partners 1-3) 240. According to an exemplary aspect, the server 210 can be configured to store information (e.g., user profiles) for location-based mobile advertising and other types of electronic information and can provide such information to the server 210 for use in disseminating targeted advertisements to users that are proximate to the business to which the advertisements correspond. It should be appreciated that the server 210 can correspond to one or more of remote server 104, public cloud 105 and/or private cloud 106 according to exemplary aspects. Moreover, the set of user devices 220 may include any type of a smart phone, a tablet, a laptop computer, a mobile computer, a desktop computer, a multimedia player, and so forth. In an aspect, server 210 corresponds to remote server 104 and/or public cloud 105 of FIG. 1, and user devices 220 each correspond to an implementation of computer 101 of FIG. 1.

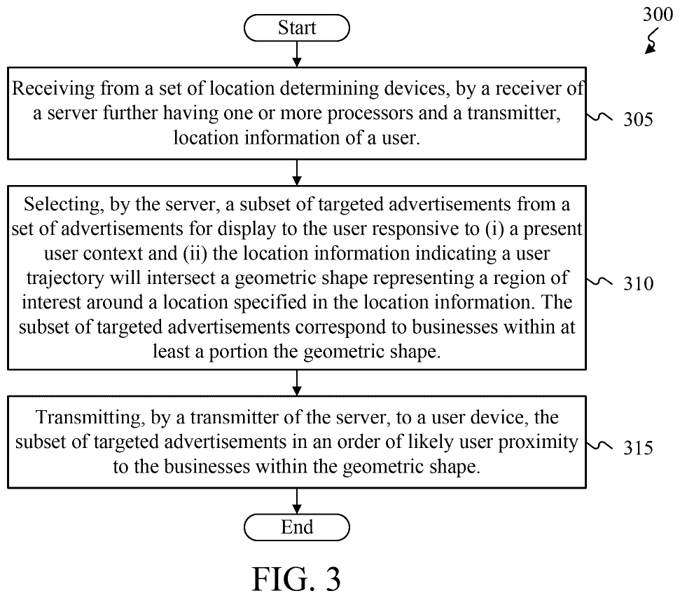

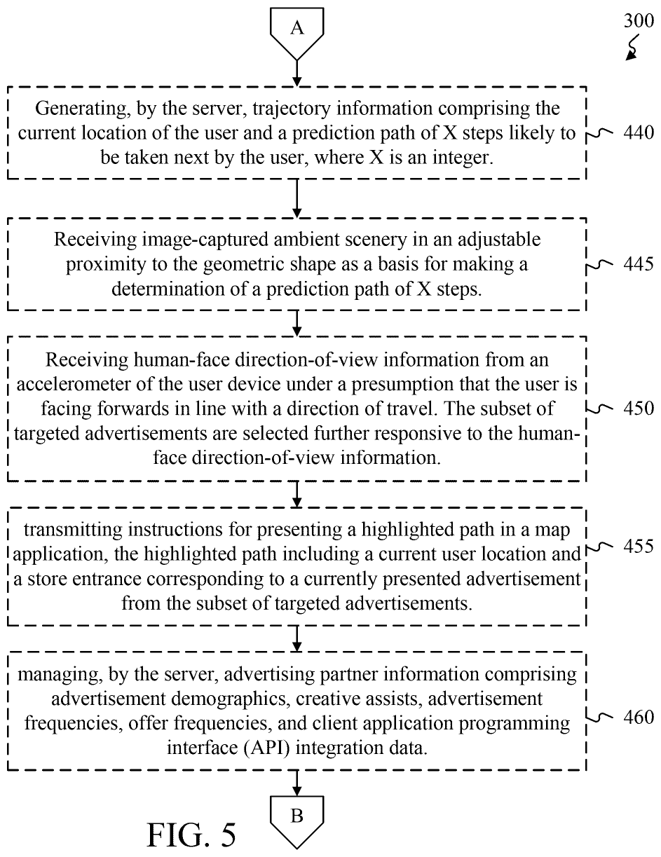

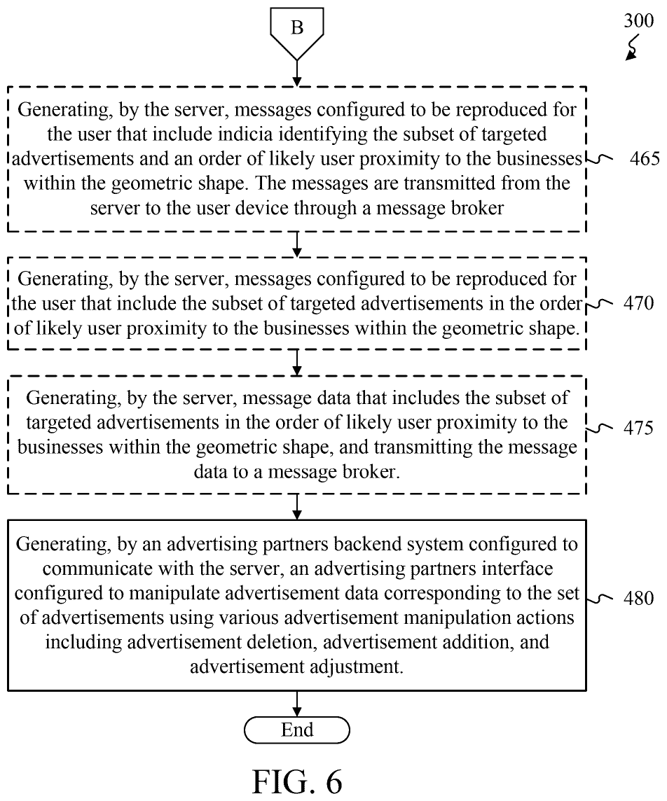

Each device in the set of user devices 220 at least includes, for example, at least one processor 220A and at least one memory 220B (which can correspond to processor set 110 of FIG. 1 in an exemplary aspect), a Global Positioning System (GPS) 220C, a communication system 220D, a display 220E, an input device 220F, an assisted GPS 220G, a WI-FI positioning system 220H, an accelerometer 220I, a camera 220J, and a speaker 220K, operatively coupled to the at least one processor 220A. Each memory 220B includes code for a method for a location-based mobile advertising service. The method may include steps from method 300 of FIG. 3-7. The at least one processor 220A may be a single or multicore processor(s), and may include a central processing unit(s) and/or a graphics processing unit(s).

The GPS system 220C typically has a location services setting that allows for authorized applications to track the location and trajectory (including direction and speed) of the user. In an aspect, a geofence 250, which can be considered a “proximity radius”, is implemented with respect to a user's location such that only businesses 230 within the geofence 250 can be considered for recommendation to the user device 210 depending on a user's profile as described more fully hereinbelow. In an aspect, only a physical portion of a business (e.g., the door(s)) is needed to be in the geofence 250 for that business to be considered when deciding which businesses to target for the user 1001 via advertising tailored for, or at the least, selected from other advertisements based on user proximity and user profile information. As used herein, the term “geofence” corresponds to a location defined boundary (e.g., a proximity radius) that may take the form of a straight line is some aspects or simply or complex shapes in other aspects. In this way, businesses may be “caught” within the geofence as the user traverses, thus resulting in the user receiving targeted e for those businesses.

The distance implemented by the geofence 250 is preferably one that coincides with a typical range that a person scans carefully when walking/traveling. The geofence 250 can be predefined and/or dynamically adjusted as described below. For example, while a person is walking in a direction, they may or may not notice businesses 230 within a given radius (e.g., a proximity radius), but are more likely to notice businesses 230 that are on a trajectory that may possibly invade their personal space or that may overlap with or get close to their personal space. Thus, a short distance for a proximity radius of 150 meters may be used in some embodiments. It should be appreciated that the proximity radius of 150 meters is predefined distance, which is exemplary, and which can be dynamically adjusted as described herein. In some aspects, the proximity radius used by the present disclosure may be user adjustable. In some aspects, the proximity radius may be adjusted based on the various criteria including closing times (stores about to close have their advertisements issued before stores that will remain open for a while longer) and user profile information (e.g., gender, age, interests, available funds for spending in one or more accounts or available on one or more types of cards such as credit and/or debit cards), and so forth.

In the aspect of FIG. 2, the server 210 at least includes, for example, at least one processor 210A and at least one memory 210B, a communication system 210C (including, e.g., a transmitter and a receiver or a transceiver), a display 210D, and an input device 210E, operatively coupled to the at least one processor 210A. Each memory 210B includes code for a method for a location-based mobile advertising service, including generating and/or dynamically adjusting the geofence 250 (e.g., the proximity radius) based on the user's location and trajectory information as described herein. The method may include steps from method 300 of FIG. 3-7. The at least one processor 210A may be a single or multicore processor(s), and may include a central processing unit(s) and/or a graphics processing unit(s).

The set of user devices 220 communicate with each other and the remote server 210 with one or more networks (collectively denoted “network”) 230.

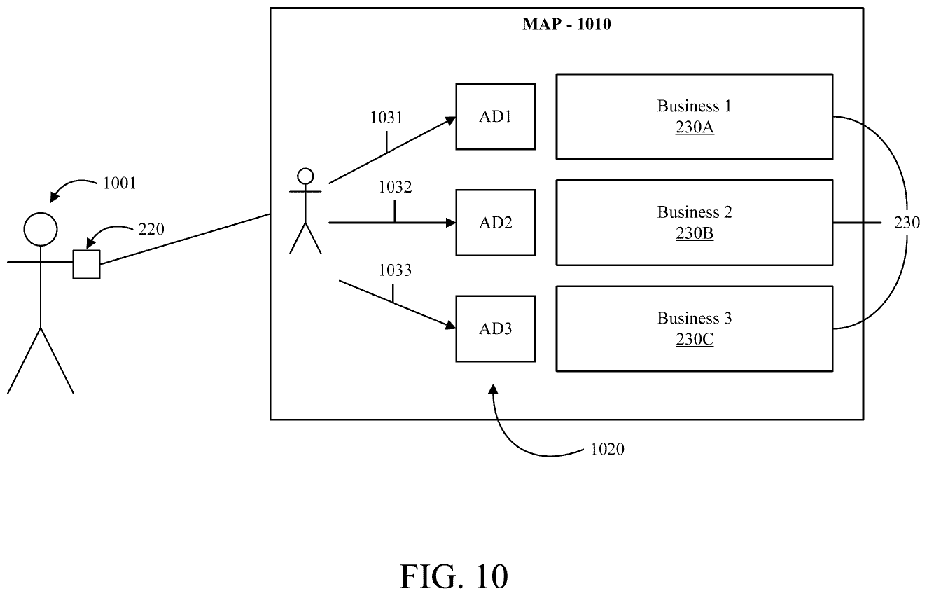

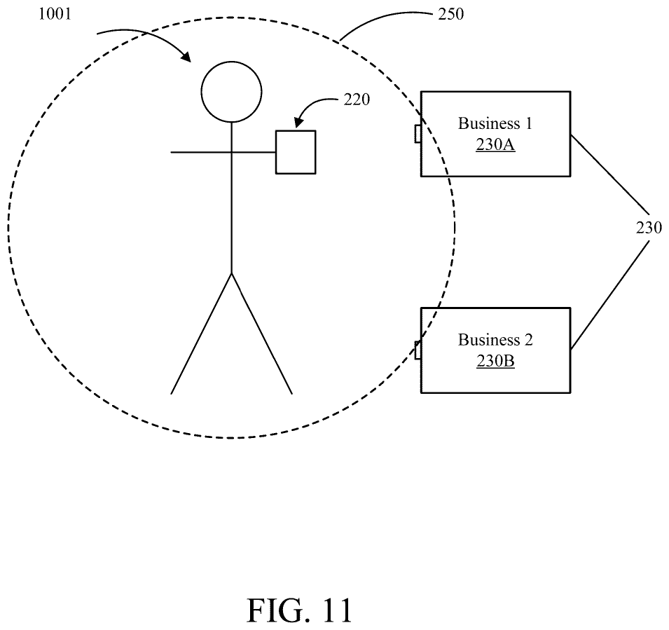

Referring to FIG. 3, an example method 300 for location-based mobile advertising is shown, in accordance with example aspects of this disclosure. See FIG. 10 for an example of how the targeted advertisements may be displayed to a user, in accordance with example aspects of this disclosure. See FIG. 11 for an example of a geofence implemented by a geometric shape, in accordance with example aspects of this disclosure.

At block 305, the method 300 includes receiving from a set of location determining devices (e.g., GPS 220C, assisted GPS 220G, WI-FI positioning system 220H, accelerometer 220I), by a receiver 210C of a server 210 further having one or more processors 210A and a transmitter 210C, location information of a user 1001. This information can used to calculate the user's current location, trajectory, and pace or speed of movement using convention location determining and GPS tracking techniques as would be understood to those skilled in the art. For example, tracking the user's current physical location over a predefined amount of time will enable the system to calculate both he heading direction and pace or speed of travel for the user, which can be considered the user's trajectory.

At block 310, the method 300 includes selecting, by the server 210, a subset of targeted advertisements 1020 from a set of advertisements for display to the user 1001 responsive to (i) a present user context and (ii) the location information indicating a user trajectory will intersect a geometric shape 250 representing a region of interest around a location specified in the location information. The subset of targeted advertisements 1020 correspond to businesses 230 within at least a portion the geometric shape 250.

At block 315, the method 300 includes transmitting, by a transmitter 210C of the server 210, to a user device 220, the subset of targeted advertisements 1020 in an order of likely user proximity to the businesses 230 within the geometric shape 250.

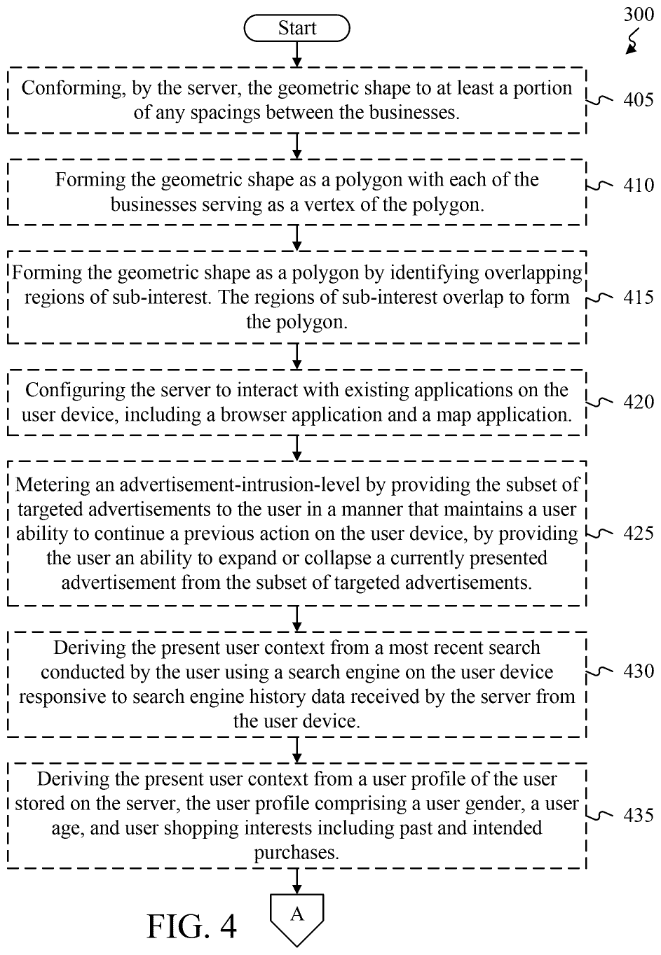

Referring to FIGS. 4-6, further steps of the method 300 of FIG. 3 are shown, in accordance with example aspects of this disclosure. It is noted that the steps of the methods shown therein can be performed in sequence or in parallel and that one or some steps may be omitted in certain instances.

At block 405, the method 400 includes conforming, by the server 210, the geometric shape 250 to at least a portion of any spacings between the businesses 230.

At block 410, the method 400 includes forming the geometric shape 250 as a polygon with each of the businesses 230 serving as a vertex of the polygon.

At block 415, the method 400 includes forming the geometric shape 250 as a polygon by identifying overlapping regions of sub-interest. The regions of sub-interest overlap to form the polygon. It should be appreciated that the polygon is an exemplary shape and other shapes can be used, such as circles, squares or the like.

At block 420, the method 400 includes configuring the server 210 to interact with existing applications stored in the one or more memories 210B on the user device 220, including a browser application and a map application.

At block 425, the method 400 includes metering an advertisement-intrusion-level by providing the subset of targeted advertisements 1020 to the user 1001 in a manner that maintains a user ability to continue a previous action on the user device 220, by providing the user an ability to expand or collapse a currently presented advertisement from the subset of targeted advertisements 1020.

At block 430, the method 400 includes deriving the present user context from a most recent search conducted by the user using a search engine on the user device 220 responsive to search engine history data received by the server 210 from the user device 220.

At block 435, the method 400 includes deriving the present user context from a user profile of the user stored on the server 210. The user profile includes a user gender, a user age, and user shopping interests including past and intended purchases. For example, the private cloud 106 can be configured to store user profile data that is either automatically collected (such as through history of the search engine) and/or entered by the user. More specifically, the user can be presented a user interface that enables the user to enter certain preferences and life style choices that would enable the system and method to provide a more customized experience for the user, which again is tied to the geolocation and trajectory as will be described herein in detail.

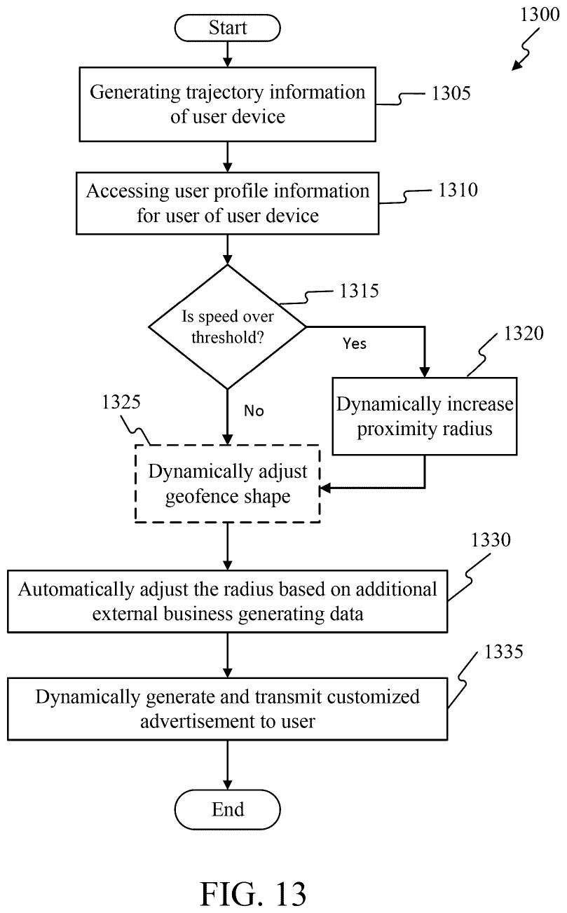

At block 440, the method 400 includes generating, by the server 210, trajectory information comprising the current location of the user and a prediction path of X steps likely to be taken next by the user, where X is an integer. As described below with respect to FIG. 13, the trajectory can be determined based on whether the user is walking or driving or some other type of transportation such as bicycling, for example.

At block 445, the method 400 incudes receiving image-captured ambient scenery in an adjustable proximity to the geometric shape as a basis for making a determination of a prediction path of X steps. In an aspect, the ambient scenery may include, e.g., existing pathways and doorways versus open fields and walls.

At block 450, the method 400 includes receiving human-face direction-of-view information from an accelerometer 220I of the user device 220 under a presumption that the user is facing forwards in line with a direction of travel. The subset of targeted advertisements are selected further responsive to the human-face direction-of-view information.

At block 455, the method 400 includes transmitting instructions for presenting a highlighted path in a map application, the highlighted path including a current user location and a store entrance corresponding to a currently presented advertisement from the subset of targeted advertisements. The instructions will be received by the user's device and configure an application, such as an application for displaying maps and directions, to illustrate the designated path.

At block 460, the method 400 includes managing, by the server, advertising partner information comprising advertisement demographics, creative assists, advertisement frequencies, offer frequencies, and client application programming interface (API) integration data.

At block 465, the method 400 includes generating, by the server, messages configured to be reproduced for the user that include indicia identifying the subset of targeted advertisements and an order of likely user proximity to the businesses within the geometric shape. The messages are transmitted from the server to the user device through a message broker. Block 465 is directed to a scenario where a message broker pre-stores advertisements for dissemination to users 1001. In an aspect, message broker is another server similar to server 210. In an aspect, message broker is a server implemented in private cloud 106 and/or public cloud 105.

At block 470, the method 400 includes generating, by the server 210, messages configured to be reproduced for the user that include the subset of targeted advertisements in the order of likely user proximity to the businesses within the geometric shape. Block 470 is directed to a scenario where messages are sent directly from the server 210 to user devices 220. In this aspect, the server 210 may be configured to calculate the user's trajectory, as described above, and then based on stored business data (which may include each businesses address) determine the order of businesses the user may encounter in the current determined trajectory and that are within the dynamically generated proximity basis. Moreover, it should be appreciated that the selected businesses will be filtered based on the present user context and user profile data as described herein.

At block 475, the method 400 includes generating, by the server 210, message data that includes the subset of targeted advertisements in the order of likely user proximity to the businesses within the geometric shape, and transmitting the message data to a message broker. Block 475 is directed to a scenario where messages are sent to a message broker that disseminates the messages to users 1001. The selected messages can be then transmitted and displayed on the user's device accordingly. It should be appreciated that they messages can be displayed within a mapping interface that displays the proximity radius and may, for example, display the travel time for the user to each business.

At block 480, the method 400 includes generating, by an advertising partners backend system configured to communicate with the server, an advertising partners interface configured to manipulate advertisement data corresponding to the set of advertisements using various advertisement manipulation actions including advertisement deletion, advertisement addition, and advertisement adjustment.

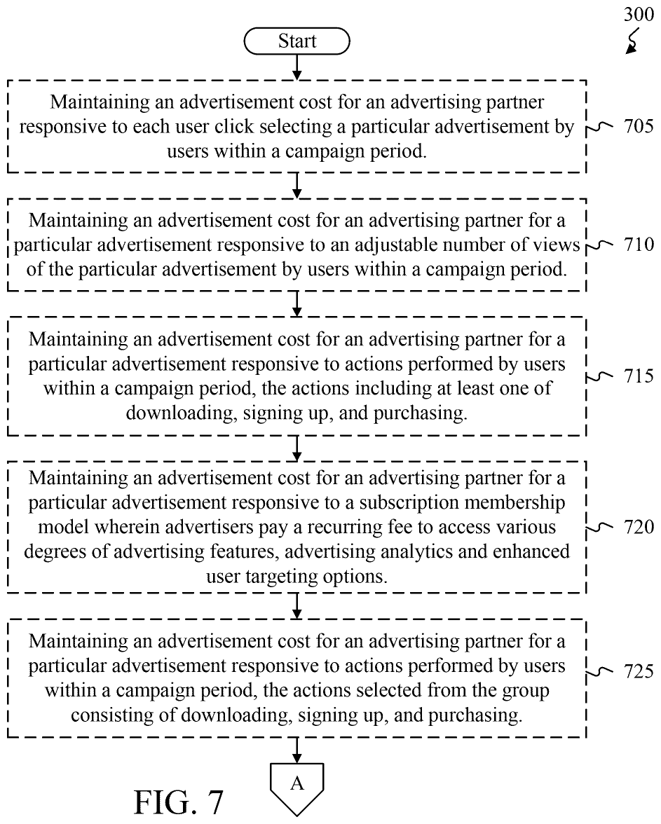

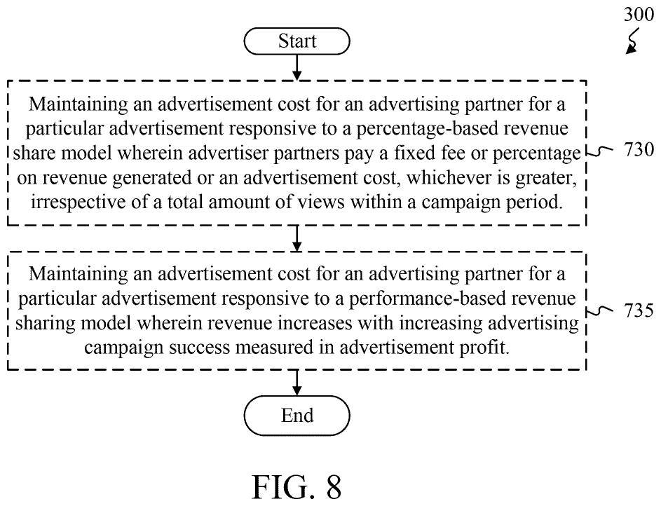

Referring to FIGS. 7-8, further steps of the method 300 of FIG. 3 directed to different monetization models are shown, in accordance with example aspects of this disclosure.

At block 705, the method 700 includes maintaining an advertisement cost for an advertising partner 240 responsive to each user click selecting a particular advertisement by users within a campaign period.

At block 710, the method 700 includes maintaining an advertisement cost for an advertising partner 240 for a particular advertisement responsive to an adjustable number of views of the particular advertisement by users within a campaign period.

At block 715, the method 700 includes maintaining an advertisement cost for an advertising partner 240 for a particular advertisement responsive to actions performed by users within a campaign period, the actions including one or more of downloading, signing up, purchasing, and so forth.

At block 720, the method 700 includes maintaining an advertisement cost for an advertising partner 240 for a particular advertisement responsive to a subscription membership model wherein advertisers pay a recurring fee to access various degrees of advertising features, advertising analytics and enhanced user targeting options.

At block 725, the method 700 includes maintaining an advertisement cost for an advertising partner 240 for a particular advertisement responsive to a percentage-based revenue share model wherein an advertising platform takes a percentage of revenue generated though the subset of target advertisements.

At block 730, the method 700 includes maintaining an advertisement cost for an advertising partner 240 for a particular advertisement responsive to a percentage-based revenue share model wherein advertiser partners 240 pay a fixed fee or percentage on revenue generated or an advertisement cost, whichever is greater, irrespective of a total amount of views within a campaign period.

At block 735, the method 700 includes maintaining an advertisement cost for an advertising partner 240 for a particular advertisement responsive to a performance-based revenue sharing model wherein revenue increases with increasing advertising campaign success measured in advertisement profit.

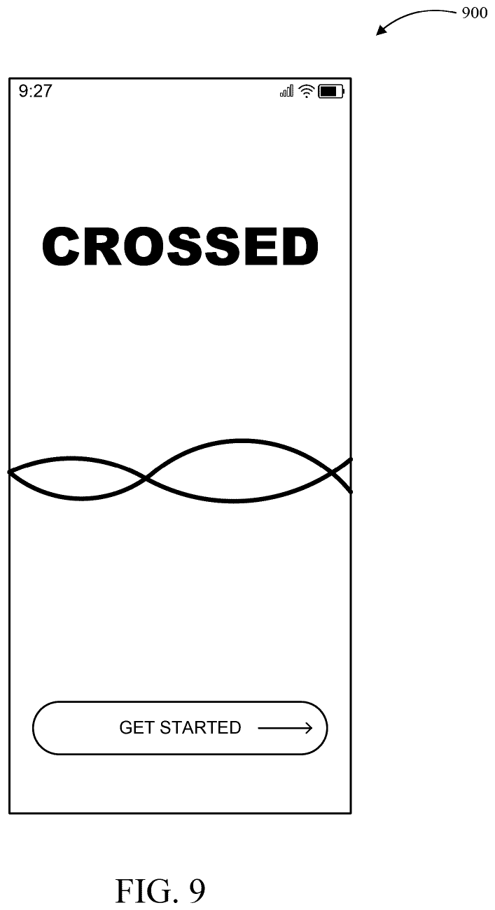

Referring to FIG. 9, an initial screen 900 for a user subscription sign up is shown, in accordance with example aspects of the present disclosure.

The initial screen 900 is followed by screens (now shown) prompting the user for their personal data including, for example, but not limited to, a telephone number, an email address, a name, an age or date of birth, a place of residence, an occupation, a preferred gender preference, and interests.

In an aspect, two-factor authentication is used once the telephone number and email address are provided to ensure the identity of the user, preferably before the application continues processing user input data.

In an aspect, the user is asked to turn on location services on their device so that their location can be tracked by the location-based mobile advertising service.

Referring to FIG. 10, a user 1001 and a user display with an open map application 1010 that uses a geofence 250 are shown, in accordance with example aspects of the present disclosure.

The user 1001 is holding their mobile device 220, with a map application 1010 opened and running.

In an aspect, the map application 1010 shows the user 1001 on the map with respect to various highlighted paths 1031, 1032, and 1033 that lead to various businesses 230A, 230B, and 230C, respectively, that are within a shape implementing a geofence 250 that corresponds to an area of interest surrounding the user 1001. Moreover, in any aspect, a subset of targeted advertisements for the businesses 230 that are within the geofence 250 are provided to the user 1001. In this way, the user 1001 may be directed to specific businesses based on targeted advertisements to the user 1001 that are provided to the user due to the user's proximity to the specific businesses and the user's profile indicating an interest in something relating to the specific businesses such as items for sale, past likes, past positive reviews, and so forth.

In the example of FIG. 10, entrances of businesses 230A, 230B, and 230C intersect trajectories of predicted paths 1031, 1032, and 10333, respectively. Thus, the user 1001 is shown advertisements AD1, AD2, and AD3 corresponding to businesses 230A, 230B, and 230C, respectively. Thus, AD1, AD2, and AD3 make up the subset of targeted advertisements that are selected from a larger group presumably corresponding to advertisements for businesses not proximate to a current user location (although they may be in the future).

Regarding path prediction, in an aspect, a user's trajectory may be predicted from a map of the surroundings including existing pathways and so forth, the user's past history (e.g., visiting a store, buying from a store, viewing items in a store but not purchasing, liking, reviewing, and so forth) when traversing the same area in the past, repeated passings by particular businesses, and user interests as specified in the user profile. Thus, for example, a man walking along a path in a mall is not likely to be shown advertisements for women's clothes and vice versa, in order to specifically target the advertisements based on user characteristics and interests specified in the user profile. Of course, the preceding may differ based the user's profile, but in any event aspects of the present disclosure specifically provide targeted advertisements to a user based on a user's profile and a user's proximity to businesses having corresponding targeted advertisements available to show the user.

In an aspect, in addition to the use of the Global Positioning System (GPS) 220C, the assisted GPS 220G, and the WI-FI positioning system 220H, on-board cameras 220A of the user device 220 may match surroundings to predetermined maps stored on the server 210 in order to know where the user is relative to businesses and what advertisements to potentially show the user, with further culling of the advertisements based on the user profile. In other words, the on-board cameras 220A may be able to capture external surroundings and determine businesses and the like that are in a proximate location to the user. In any event, using this data, from a larger set of advertisements, a first subset of advertisements may be determined based on user proximity and possibly also user trajectory, and a second subset of advertisements from the first subset of advertisements may be determined based on user's profile. In this way, multiple layers of culling of a large set of advertisements may be efficiently performed to arrive at an appropriate subset of target advertisements to send to the user 1001.

In an aspect, a user 1001 is located on the map and their representation on the map will cause beeping or other sounds from a speaker 220K of the user device 220 to become louder as they approach a business for which they have asked for directions, or in another aspect, their representation on the map may become brighter or change in some user visually perceptible way (e.g., flash, etc.). In this way, a user can be directed to a business of interest from clicking on links in the advertisements for directions and other features such as dynamically created paths on the map from a current user location to a corresponding business entrance corresponding to an advertisement the user has expressed further interest in via a slider or other mechanism related to path generation on the map 1010.

Referring to FIG. 11, a user and a geofence are shown, in accordance with example aspects of the present disclosure.

In FIG. 11, entrances of businesses 230A and 230B intersect geofence 250, implemented here as the geometric shape of a circle, noting that other geometric shapes can be used. Such shapes can be tailored to the layout of the business such as to place vertexes of polygons at entrances of the business to demark them more easily versus a circle for example. To further elaborate, not every vertex position need correspond to a business or business entrance, but using vertexes easily demarks businesses than simply points on a circle. Of course, other shapes including a circle as shown may be used.

Thus, in the preceding example of FIG. 11, businesses 230A and 230B will have their advertisements shown to the user since those business are within the geofence or location boundary(ies) surrounding the user. The range of targeting a user with respect to the location of a business may be adjusted by a system administrator or tailored by each user to their own tastes and moods (e.g., in or not in a shopping mood). As will be discussed in more detail below with respect to FIG. 13, the system may be configured to dynamically and/or automatically adjust the radius (e.g., a best radius) to optimize system efficient based on different features, such as real-time foot traffic, user engagement, and outside factors, such as weather and commercial events.

In any event, it is noted that a map application is not needed in an exemplary aspect, and the user 1001 is simply presented the subset of advertisements on the user's device. In any aspect, the advertisement are provided in a manner that does not fully intrude with the screen space such as a small icon indicating a relevant advertisement(s) can be viewed should the user want to view the advertisement such that clicking on the icon makes the full advertisement appear.

In an aspect, as the user 1001 gets closer to the relevant business 230 to the advertisement they are currently viewing, their phone may produce a louder sound or stronger vibration to indicate increased proximity to the relevant business 230.

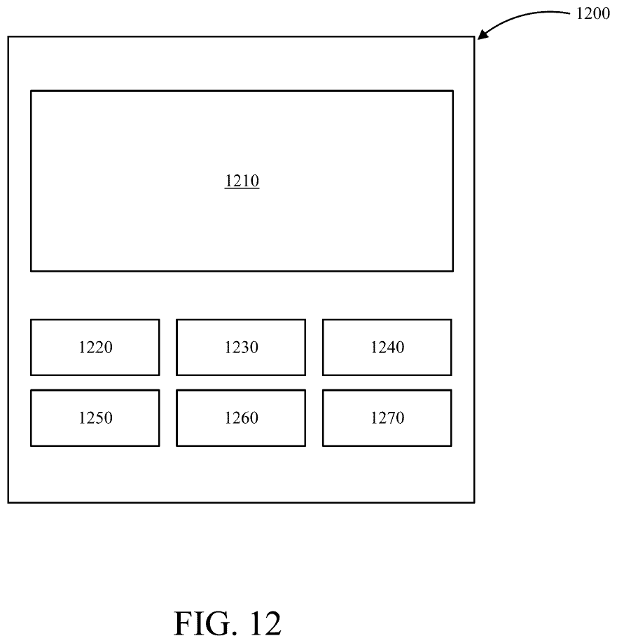

Referring to FIG. 12, a targeted advertisement 1200 from a subset of targeted advertisements is shown, in accordance with example aspects of the present disclosure.

The targeted advertisement 1200 includes ad content 1210, a distance to a business 230 corresponding to the targeted advertisement 1200, a slider 1220 to initiate the generation of a path to the business 230 corresponding to the targeted advertisement 1200, a slider 1230 to initiate sound directions to the business corresponding to the targeted advertisement 1200, a slider 1240 to request other current advertisements from the same business. These additional advertisements can be selected by a sider 1250 to be able to be based simply on proximity while removing the user profile component, and so forth. In this way, a user 1001 in a particular business 230 looking for items of interest to them may be shown other items that may be of interest to them for the purpose of gifting other people. Hence, some aspects of the present disclosure may have a timing aspect to them such that more diverse items (e.g., items not necessarily of interest based on user profile) are shown to the user at holidays such as around Christmas to broaden the targeted advertisement scope.

In an aspect, the selection of the subset of targeted advertisements that are provided to the user is made using artificial intelligence. For example, one or more specially programmed neural networks may be used to predict a subset of advertisements the user would be interested in based on the user's profile, user's past history (purchasing history, browsing history, advertisement history and corresponding success), and the user's proximity to businesses to which the subset of advertisements correspond. The one or more neural networks take in a user profile, user's past history, and a user's location relative to a business, to reduce an error in showing the user an advertisement that will lead to a purchase. No purchase results in increasing the error of a shown advertisement, while a purchase will decrease the error of a shown advertisement. In this way, the model formed from one or more neural networks may be trained. Again, reinforcement or other types of artificial intelligence and neural networks such as convolutional neural networks employing weights may be used for the advertisement subset selection to show a user at a given moment in time. Weights in a convolutional neural network can be adjusted/set based on prior purchase history, advertisement success with other users, and so forth. The system will dynamically adjust the advertisement selection shown to the user 1001 based on dynamic changes in a user's location, noting that less dynamic changes may also be implemented according to schedule such that the user's profile is reviewed every day, hour, and so forth, for changes that may affect advertisement selection. In the event of equal distance to businesses, ties may be broken based on user profile data and/or prior purchase history at the business. These and other ways may be used to break distance ties as far as ad order of advertisements being provided to the user 1001.

In an aspect, an interest meter 1260 may be shown that indicates a predicted user interest in the subject matter (ad content 1210) of an advertisement. The interest meter 1260 may be driven by an artificial intelligence network 1270 that uses one or more neural networks to predict user interests based on their prior purchases, where the artificial intelligence network learns user habits and thus appropriate predictions based on positive and/or negative reinforcement based on prior buying history with respect to targeted location-based mobile advertising. For example, advertisements resulting in all purchases will be repeated compared to advertisements for items that never result in a purchase. Moreover, advertisements resulting in all purchases will result in a higher interest level than an almost zero interest level for advertisements never resulting in purchases. Other approaches to configuring one or more neural networks to accomplish the features of the present disclosure may be used in place of reinforcement learning. However, it is envisioned that an aspect of the present disclosure implementing path prediction uses neural networks, takes a current business and advertisement and compares it to prior advertisement for that business and, in an aspect, other similar advertisements of similar or the same business, to make a prediction and reduce an ongoing prediction error until convergence, or a number of iterations have been reached, or a threshold level of error has been reached, and so forth.

FIG. 13 illustrates a method 1300 that is provided for adjusting the geofence or proximity radius according to an exemplary aspect. As described above, the distance implemented by the geofence 250 generally is configured to coincide with a typical range (e.g., a predetermined range) and in a direction (i.e., a trajectory) that may possibly cross their personal space or that may overlap with or get close to their personal space. Moreover, the proximity radius may be user adjustable, for example, by using the application on user device 220 to set a desired distance.

However, in an alternative aspect, the proximity radius may be automatically and/or dynamically adjusted to optimize the business's reach to a target customer. In this aspect, the system initially determines a trajectory of a user (e.g., the user's mobile device) at block 1305, which as described above can be determined by generating, by the server 210, trajectory information comprising the current location of the user and a prediction path of X steps likely to be taken next by the user, where X is an integer. It should be appreciated that the trajectory can include both direction and speed, which will both factor in to determining the size and shape of the proximity radius.

Next, at block 1310, the system accesses user profile information, which can include gender, age, interests (which may be customized by the user), available funds for spending in one or more accounts or available on one or more types of cards such as credit and/or debit cards and the like. As described above, the user profile information can be stored in private cloud 106 and can be customized by the user. For the example, a database can be provided in which the user can define preferences (e.g., types of cuisine, hobbies, music preferences) and the like.

As noted above, the initial proximity radius may be a predefined distance (e.g., 150 meters). At block 1315, the system may be configured to dynamically adjust the proximity radius based on the trajectory, including both speed and direction, of the user. For example, if the user's average speed is over a predefined speed threshold (e.g., 15 MPH) over a predefined time period (e.g., five minutes), the method can determine that the user is traveling in a car and therefore can be configured to dynamically adjust and increase the proximately radius (e.g., 3 miles or 5 miles) based on the average speed, for example, at block 1320. In other words, the system can be configured to dynamically predict how far the user may travel over the next 15 minutes and adjust the proximity radius encompass possible business locations that the user would intersect within that time period.

Moreover, at block 1325, the method can be configured to dynamically adjust the shape of the geofence based on the determined trajectory of the user. Block 1325 is shown in dashes to illustrate it is an optional step. In this case, if the system determines that the user is in a car driving as described above, the system may adjust the geofence such that the shape encompasses business that are only of outward projecting businesses. For example, as shown in FIG. 2, user device 1 is shown to be in the middle of geofence 250. This shape may be acceptable for a user that is walking in a city where the user can easily change directions and even go backwards. However, a user driving in a car (especially on the highway) will be unlikely and/or unwilling to go backwards. Therefore, the system at block 1325 may adjust the shape of the geofence to account for the trajectory. For example, if user device 3 in FIG. 2 is considered to be heading north (e.g., in the upwards direction of the page), the geofence 250 is configured as a shape that only encompasses potential business that may intersect the expected path of the user.

Yet further, at block 1330, the method may further be configured to automatically adjust the radius based on additional external business generating data, such as real-time foot traffic, user engagement, time, weather and commercial events. That is, server 210 may be configured to collect this data from third-party sources, such weather and data services, or the specific business themselves that are providing information on food traffic. Based on this data, the system may be configured to dynamically adjust the proximity radius to account for these external business driving data.

At block 1335, a customized advertisement may be generated based on the external business generating data and for any business that falls within the adjusted proximity zone as determined at blocks 1320, 1325 and/or 1330. For example, if the system determines based on the user profile that the user is a “coffee drinker” and it is early in the morning (e.g., 7 am), the system may identify a coffee shop, such as Starbucks®, that is within the adjusted proximity radius and also that may have light foot traffic (or other waiting time) at the current time. The advertisement may be transmitted to the user to prompt the user to stop at the coffee shop and indicate that the waiting time is less than a predetermined threshold, such as five minutes. In yet a refinement of this aspect, the system may also enable the user to invoke an automatic purchase by offering customized advertisements of the type of coffee known that the user likes, so that the user can preorder the coffee with a simple click.

Another example, may be if the user is walking through a town (e.g., on holiday) and the weather indicates that it will begin raining soon. The proximity radius may be adjusted to account for all restaurants or taverns that the user can walk to (based on the determined trajectory) before it starts raining. Using this smart proximity boosting technique by dynamically and automatically adjusting the proximity radius, the system can enable businesses and users to optimize their reach without wasting budget or inefficiencies of unwanted advertisements.

In yet a refinement of the exemplary method shown in FIG. 13, block 1335 can also be modified to prioritize different types of advertising based on the distance and trajectory of the user. As described above, the generated trajectory of the user can be used to determine the direction and distance the user will be from the current point at a given time. In an exemplary aspect, the system (e.g., server 210) can be configured determine a threshold (e.g., based on time) for businesses the user will encounter in view of his or her trajectory. For example, if the user will encounter businesses within the predetermined time threshold (e.g., 30 minutes), the system may be configured to generate a first type of advertising (e.g., flash sales) whereas if the user will encounter businesses outside of the predetermined time threshold (e.g., 30 minutes), the system may be configured to generate a second type of advertising (e.g., long-rang advertising for general branding). This layered advertising based on proximity enables the system and method described herein to provide a more

In accordance with various aspects of this disclosure, one or more of the following features may be provided.
Precision Targeting: The system and method enables pinpoint accuracy allows for delivery of hyper-localized and targeted advertisements, ensuring that users receive offers relevant to their immediate surroundings.
Real-Time Engagement: Users receive timely and contextually relevant promotions, enhancing the likelihood of conversion by presenting offers when they matter most.
User-Friendly Experience: With a focus on seamless integration, the proposed location-based mobile advertising service enhances the overall user experience, providing valuable content without intrusion.
Advertising Partner Network: A diverse range of advertising partners strategically positioned within a geofence implementing, for example, a 150-meter or other sized radius or shape, can create creating a dynamic ecosystem for targeted promotions.
Data Privacy: In an aspect, the proposed location-based mobile advertising service offers a one-way data set to safeguard user data, ensuring APN analytics can be provided for user interactions without unveiling intact user profile data.

In accordance with various aspects of this disclosure, one or more of the following benefits may be obtained:
Increased Foot Traffic: The proposed location-based mobile advertising service drives users to the physical locations of advertising partners, boosting foot traffic and encouraging real-world engagement.
Higher Conversion Rates: The contextual relevance of offers delivered in proximity to users increases the likelihood of conversions, maximizing the impact of advertising campaigns.
Enhanced Brand Visibility: The proposed location-based mobile advertising service establishes a stronger presence in the local market by reaching users when they are most likely to interact with your brand.
Data-Driven Insights: Leverage comprehensive analytics to gain valuable insights into user behavior, campaign performance, and overall ROI.

In accordance with various aspects of this disclosure, one or more of the following geolocation systems may be used:
GPS (Global Positioning System): The proposed location-based mobile advertising service may utilize the GPS hardware embedded in smartphones to obtain accurate location data.
Assisted GPS (A-GPS): The proposed location-based mobile advertising service uses assisted GPS to improve location accuracy, especially in urban areas or areas with weak GPS signals, by combining satellite data with other sources.
WI-FI Positioning System: The proposed location-based mobile advertising service uses WI-FI signals to triangulate the user's position, which is particularly effective in indoor environments.

In accordance with various aspects of this disclosure, server-side development may involve one or more of the following:
Backend Framework that includes a scalable database configured to store: (i) user profiles, (ii) location history, (iii) Advertising partner information (including Ad Demographics, Creative assists, Ad frequency, Offer frequency, Client API integration or CTA's for offer purchases and the like), and (iv) geospatial Database Extensions: Relating to or denoting data that is associated with a particular location. For efficient storage and retrieval of geospatial data. In other words, the businesses are generally in a fixed geolocation while the user's location and trajectory can be determined according to the methods described herein. This information can then be used to determine the relevant and targeted business within the defined and dynamically adjustable geofence.

As further described herein, the system and method described herein provides for an advertising partner integration, which essentially can be considered an APN (Advertising Partner Network) Access Dashboard in which an advertising partners interface or backend system enables businesses to view and/or create targeted offers and retrieve relevant user impression data based on the various parameters described herein.

It should be appreciated that various monetization models can be implemented using the methods and systems described herein. For example, a Cost-Per-Click (CPC) system can be implemented where the advertisers (e.g., the business) pay a fee each time a user clicks on their advertisement. This enables the advertisers to only pay for actual engagement with their content, and it is a measurable metric. In another example, the system and method is suitable for campaigns aiming to drive traffic to the advertiser's website or app, such as Cost-Per-Meter (CPM), where the advertisers (e.g., the business) pay a fee for every 1,000 impressions (views), for example, of their ad, regardless of clicks. In another example, a Cost-Per-Action (CPA) is implemented where advertisers (e.g., the business) pay when a specific action(s) is(are) completed, such as, for example, but not limited to, a download, sign-up, or (and) a purchase.

Yet further, the system and method described herein can provide for revenue sharing arrangements, such as a percentage based revenue share where the advertising platform takes a percentage of the revenue generated through advertisements served on the platform. This arrangement would align the platform's success with the success of its advertising partners, of which the approach is suitable for platforms that provide a comprehensive suite of services. In another example, a fixed-fee revenue share percentage of ad spend typically 10%-15%, in which advertising partners pay a fixed fee or percentage on the revenue generated or ad spend whichever is greater, regardless of the total amount of views within a campaign period.
Clause 1. A method for location-based advertisement, comprising: receiving from a set of location determining devices, by a receiver of a server further having one or more processors and a transmitter, location information of a user; selecting, by the server, a subset of targeted advertisements from a set of advertisements for display to the user responsive to (i) a present user context and (ii) the location information indicating a user trajectory will intersect a geometric shape representing a region of interest around a location specified in the location information, the subset of targeted advertisements corresponding to businesses within at least a portion the geometric shape; and transmitting, by a transmitter of the server, to a user device, the subset of targeted advertisements in an order of likely user proximity to the businesses within the geometric shape.
Clause 2. The method in accordance with clause 1, further comprising conforming, by the server, the geometric shape to at least a portion of any spacings between the businesses.
Clause 3. The method in accordance with any preceding clauses, further comprising forming the geometric shape as a polygon with each of the businesses serving as a vertex of the polygon.
Clause 4. The method in accordance with any preceding clauses, further comprising forming the geometric shape as a polygon by identifying overlapping regions of sub-interest, wherein the regions of sub-interest overlap to form the polygon.
Clause 5. The method in accordance with any preceding clauses, further comprising configuring the server to interact with existing applications on the user device, including a browser application and a map application.
Clause 6. The method in accordance with any preceding clauses, further comprising metering an advertisement-intrusion-level by providing the subset of targeted advertisements to the user in a manner that maintains a user ability to continue a previous action on the user device, by providing the user an ability to expand or collapse a currently presented advertisement from the subset of targeted advertisements.
Clause 7. The method in accordance with any preceding clauses, wherein the location information comprises a current location of the user, and the method further comprises generating, by the server, trajectory information comprising the current location of the user and a prediction path of X steps likely to be taken next by the user, where X is an integer.
Clause 8. The method in accordance with any preceding clauses, further comprising receiving image-captured ambient scenery in an adjustable proximity to the geometric shape as a basis for making a determination of a prediction path of X steps. NOTE: For specification: In an aspect, the ambient scenery may include, e.g., existing pathways and doorways versus open fields and walls.
Clause 9. The method in accordance with any preceding clauses, further comprising receiving human-face direction-of-view information from an accelerometer of the user device under a presumption that the user is facing forwards in line with a direction of travel, and wherein the subset of targeted advertisements are selected further responsive to the human-face direction-of-view information.
Clause 10. The method in accordance with any preceding clauses, wherein the set of location determining devices comprise a global position system (GPS), an assisted GPS, and a WI-FI positioning system.
Clause 11. The method in accordance with any preceding clauses, further comprising transmitting instructions for presenting a highlighted path in a map application, the highlighted path including a current user location and a store entrance corresponding to a currently presented advertisement from the subset of targeted advertisements.
Clause 12. The method in accordance with any preceding clauses, further comprising managing, by the server, advertising partner information comprising advertisement demographics, creative assists, advertisement frequencies, offer frequencies, and client application programming interface (API) integration data.
Clause 13. The method in accordance with any preceding clauses, further comprising generating, by the server, messages configured to be reproduced for the user that include indicia identifying the subset of targeted advertisements and an order of likely user proximity to the businesses within the geometric shape, wherein the messages are transmitted from the server to the user device through a message broker. NOTE: covers case where message broker pre-stores advertisements as a way to circumvent.
Clause 14. The method in accordance with any preceding clauses, further comprising generating, by the server, messages configured to be reproduced for the user that include the subset of targeted advertisements in the order of likely user proximity to the businesses within the geometric shape. NOTE: covers case where messages are sent directly from server to user
Clause 15. The method in accordance with any preceding clauses, further comprising: generating, by the server, message data that includes the subset of targeted advertisements in the order of likely user proximity to the businesses within the geometric shape; and transmitting the message data to a message broker. NOTE: covers case where message sent to message broker where message broker disseminates the messages to user
Clause 16. The method in accordance with any preceding clauses, further comprising generating, by an advertising partners backend system configured to communicate with the server, an advertising partners interface configured to manipulate advertisement data corresponding to the set of advertisements using various advertisement manipulation actions comprising advertisement deletion, advertisement addition, and advertisement adjustment. NOTE: Claims 17-23 directed to different monetization models
Clause 17. The method in accordance with any preceding clauses, further comprising maintaining an advertisement cost for an advertising partner responsive to each user click selecting a particular advertisement by users within a campaign period.
Clause 18. The method in accordance with any preceding clauses, further comprising maintaining an advertisement cost for an advertising partner for a particular advertisement responsive to an adjustable number of views of the particular advertisement by users within a campaign period.
Clause 19. The method in accordance with any preceding clauses, further comprising maintaining an advertisement cost for an advertising partner for a particular advertisement responsive to actions performed by users within a campaign period, the actions selected from the group consisting of downloading, signing up, and purchasing.
Clause 20. The method in accordance with any preceding clauses, further comprising maintaining an advertisement cost for an advertising partner for a particular advertisement responsive to a subscription membership model wherein advertisers pay a recurring fee to access various degrees of advertising features, advertising analytics and enhanced user targeting options.
Clause 21. The method in accordance with any preceding clauses, further comprising maintaining an advertisement cost for an advertising partner for a particular advertisement responsive to a percentage-based revenue share model wherein an advertising platform takes a percentage of revenue generated though the subset of target advertisements.
Clause 22. The method in accordance with any preceding clauses, further comprising maintaining an advertisement cost for an advertising partner for a particular advertisement responsive to a percentage-based revenue share model wherein advertising partners pay a fixed fee or percentage on revenue generated or an advertisement cost, whichever is greater, irrespective of a total amount of views within a campaign period.
Clause 23. The method in accordance with any preceding clauses, further comprising maintaining an advertisement cost for an advertising partner for a particular advertisement responsive to a performance-based revenue sharing model wherein revenue increases with increasing advertising campaign success measured in advertisement profit.
Clause 24. The method in accordance with any preceding clauses, wherein at least some of the location determining devices in the set are comprised in the user device.
Clause 25. A server for location-based advertisement, comprising: a receiver configured to receive location information of a user from a set of location determining devices; one or more memories, individually or in combination, having instructions; one or more processors each coupled to at least one of the one or more memories and configurable/operable to execute the instructions to select a subset of targeted advertisements from a set of advertisements for display to the user responsive to (i) a present user context and (ii) the location information indicating a user trajectory will intersect a geometric shape representing a region of interest around a location specified in the location information, the subset of targeted advertisements corresponding to businesses within at least a portion the geometric shape; and a transmitter configured transmit the subset of targeted advertisements in an order of likely user proximity to the businesses within the geometric shape.

Various aspects of the disclosure may take the form of an entirely or partially hardware aspect, an entirely or partially software aspect, or a combination of software and hardware. Furthermore, as described herein, various aspects of the disclosure (e.g., systems and methods) may take the form of a computer program product comprising a computer-readable non-transitory storage medium having computer-accessible instructions (e.g., computer-readable and/or computer-executable instructions) such as computer software, encoded or otherwise embodied in such storage medium. Those instructions can be read or otherwise accessed and executed by one or more processors to perform or permit the performance of the operations described herein. The instructions can be provided in any suitable form, such as source code, compiled code, interpreted code, executable code, static code, dynamic code, assembler code, combinations of the foregoing, and the like. Any suitable computer-readable non-transitory storage medium may be utilized to form the computer program product. For instance, the computer-readable medium may include any tangible non-transitory medium for storing information in a form readable or otherwise accessible by one or more computers or processor(s) functionally coupled thereto. Non-transitory storage media can include read-only memory (ROM); random access memory (RAM); magnetic disk storage media; optical storage media; flash memory, and so forth.

Aspects of this disclosure are described herein with reference to block diagrams and flowchart illustrations of methods, systems, apparatuses, and computer program products. It can be understood that each block of the block diagrams and flowchart illustrations, and combinations of blocks in the block diagrams and flowchart illustrations, respectively, can be implemented by computer-accessible instructions. In certain implementations, the computer-accessible instructions may be loaded or otherwise incorporated into a general-purpose computer, a special-purpose computer, or another programmable information processing apparatus to produce a particular machine, such that the operations or functions specified in the flowchart block or blocks can be implemented in response to execution at the computer or processing apparatus.

Unless otherwise expressly stated, it is in no way intended that any protocol, procedure, process, or method set forth herein be construed as requiring that its acts or steps be performed in a specific order. Accordingly, where a process or method claim does not actually recite an order to be followed by its acts or steps, or it is not otherwise specifically recited in the claims or descriptions of the subject disclosure that the steps are to be limited to a specific order, it is in no way intended that an order be inferred, in any respect. This holds for any possible non-express basis for interpretation, including: matters of logic with respect to the arrangement of steps or operational flow; plain meaning derived from grammatical organization or punctuation; the number or type of aspects described in the specification or annexed drawings; or the like.

As used in this disclosure, including the annexed drawings, the terms “component,” “module,” “system,” and the like are intended to refer to a computer-related entity or an entity related to an apparatus with one or more specific functionalities. The entity can be either hardware, a combination of hardware and software, software, or software in execution. One or more of such entities are also referred to as “functional elements.” As an example, a component can be a process running on a processor, a processor, an object, an executable, a thread of execution, a program, and/or a computer. For example, both an application running on a server or network controller, and the server or network controller can be a component. One or more components can reside within a process and/or thread of execution and a component can be localized on one computer and/or distributed between two or more computers. Also, these components can execute from various computer readable media having various data structures stored thereon. The components can communicate via local and/or remote processes such as in accordance with a signal having one or more data packets (e.g., data from one component interacting with another component in a local system, distributed system, and/or across a network such as the Internet with other systems via the signal). As another example, a component can be an apparatus with specific functionality provided by mechanical parts operated by electric or electronic circuitry, which parts can be controlled or otherwise operated by program code executed by a processor. As yet another example, a component can be an apparatus that provides specific functionality through electronic components without mechanical parts, the electronic components can include a processor to execute program code that provides, at least partially, the functionality of the electronic components. As still another example, interface(s) can include I/O components or Application Programming Interface (API) components. While the foregoing examples are directed to aspects of a component, the exemplified aspects or features also apply to a system, module, and similar.

In addition, the term “or” is intended to mean an inclusive “or” rather than an exclusive “or.” That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. Moreover, articles “a” and “an” as used in this specification and annexed drawings should be construed to mean “one or more” unless specified otherwise or clear from context to be directed to a singular form.

In addition, the terms “example” and “such as” are utilized herein to mean serving as an instance or illustration. Any aspect or design described herein as an “example” or referred to in connection with a “such as” clause is not necessarily to be construed as preferred or advantageous over other aspects or designs described herein. Rather, use of the terms “example” or “such as” is intended to present concepts in a concrete fashion. The terms “first,” “second,” “third,” and so forth, as used in the claims and description, unless otherwise clear by context, is for clarity only and does not necessarily indicate or imply any order in time or space.

The term “processor,” as utilized in this disclosure, can refer to any computing processing unit or device comprising processing circuitry that can operate on data and/or signaling. A computing processing unit or device can include, for example, single-core processors; single-processors with software multithread execution capability; multi-core processors; multi-core processors with software multithread execution capability; multi-core processors with hardware multithread technology; parallel platforms; and parallel platforms with distributed shared memory. Additionally, a processor can include an integrated circuit, an application specific integrated circuit (ASIC), a digital signal processor (DSP), a field programmable gate array (FPGA), a programmable logic controller (PLC), a complex programmable logic device (CPLD), a discrete gate or transistor logic, discrete hardware components, or any combination thereof designed to perform the functions described herein. In some cases, processors can exploit nano-scale architectures, such as molecular and quantum-dot based transistors, switches and gates, in order to optimize space usage or enhance performance of user equipment. A processor may also be implemented as a combination of computing processing units.

In addition, terms such as “store,” “data store,” data storage,” “database,” and substantially any other information storage component relevant to operation and functionality of a component, refer to “memory components,” or entities embodied in a “memory” or components comprising the memory. It will be appreciated that the memory components described herein can be either volatile memory or nonvolatile memory, or can include both volatile and nonvolatile memory. Moreover, a memory component can be removable or affixed to a functional element (e.g., device, server).

Simply as an illustration, nonvolatile memory can include read only memory (ROM), programmable ROM (PROM), electrically programmable ROM (EPROM), electrically erasable ROM (EEPROM), or flash memory. Volatile memory can include random access memory (RAM), which acts as external cache memory. By way of illustration and not limitation, RAM is available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), and direct Rambus RAM (DRRAM). Additionally, the disclosed memory components of systems or methods herein are intended to comprise, without being limited to comprising, these and any other suitable types of memory.

Various aspects described herein can be implemented as a method, apparatus, or article of manufacture using standard programming and/or engineering techniques. In addition, various of the aspects disclosed herein also can be implemented by means of program modules or other types of computer program instructions stored in a memory device and executed by a processor, or other combination of hardware and software, or hardware and firmware. Such program modules or computer program instructions can be loaded onto a general-purpose computer, a special-purpose computer, or another type of programmable data processing apparatus to produce a machine, such that the instructions which execute on the computer or other programmable data processing apparatus create a means for implementing the functionality of disclosed herein.

The term “article of manufacture” as used herein is intended to encompass a computer program accessible from any computer-readable device, carrier, or media. For example, computer readable media can include but are not limited to magnetic storage devices (e.g., hard drive disk, floppy disk, magnetic strips, or similar), optical discs (e.g., compact disc (CD), digital versatile disc (DVD), blu-ray disc (BD), or similar), smart cards, and flash memory devices (e.g., card, stick, key drive, or similar).

The detailed description set forth herein in connection with the annexed figures is intended as a description of various configurations or implementations and is not intended to represent the only configurations or implementations in which the concepts described herein may be practiced. The detailed description includes specific details for the purpose of providing a thorough understanding of various concepts. However, it will be apparent to those skilled in the art that these concepts may be practiced without these specific details or with variations of these specific details. In some instances, well-known components are shown in block diagram form, while some blocks may be representative of one or more well-known components.

The previous description of the disclosure is provided to enable a person skilled in the art to make or use the disclosure. Various modifications to the disclosure will be readily apparent to those skilled in the art, and the common principles defined herein may be applied to other variations without departing from the scope of the disclosure. Furthermore, although elements of the described aspects may be described or claimed in the singular, the plural is contemplated unless limitation to the singular is explicitly stated. Additionally, all or a portion of any aspect may be utilized with all or a portion of any other aspect, unless stated otherwise. Thus, the disclosure is not to be limited to the examples and designs described herein but is to be accorded the widest scope consistent with the principles and novel features disclosed herein.

What is claimed is:

1. A method for transmitting data to a user based on a location and trajectory, the method comprising:
receiving from a location determining device, by a receiver of a server having one or more processors and a transmitter, location information and trajectory information of a user;
generating a geometric shape representing a physical region of interest based on the location information and a user trajectory of the user based on the trajectory information;
selecting, by the server, a subset of targeted advertisements from a set of advertisements for display to the user responsive to (i) a present user context and (ii) the location information indicating the user trajectory will intersect the geometric shape representing the physical region of interest specified in the location information, the subset of targeted advertisements corresponding to businesses within at least a portion the geometric shape and based on the present user context; and
transmitting, by a transmitter of the server to a user device of the user, the subset of targeted advertisements in an order of likely user proximity to the businesses within the geometric shape.

2. The method in accordance with claim 1, further comprising conforming, by the server, the geometric shape to at least a portion of any spacings between the businesses.

3. The method in accordance with claim 1, further comprising forming the geometric shape as a polygon with each of the businesses serving as a vertex of the polygon.

4. The method in accordance with claim 1, further comprising forming the geometric shape as a polygon by identifying overlapping regions of sub-interest, wherein the regions of sub-interest overlap to form the polygon.

5. The method in accordance with claim 1, further comprising configuring the server to interact with existing applications on the user device, including a browser application and a map application.

6. The method in accordance with claim 1, further comprising metering an advertisement-intrusion-level by providing the subset of targeted advertisements to the user in a manner that maintains a user ability to continue a previous action on the user device, by providing the user an ability to expand or collapse a currently presented advertisement from the subset of targeted advertisements.

7. The method in accordance with claim 1, wherein the location information comprises a current location of the user, and the method further comprises generating, by the server, trajectory information comprising the current location of the user and a prediction path of X steps likely to be taken next by the user, where X is an integer.

8. The method in accordance with claim 1, further comprising receiving image-captured ambient scenery in an adjustable proximity to the geometric shape as a basis for making a determination of a prediction path of X steps.

9. The method in accordance with claim 1, further comprising receiving human-face direction-of-view information from an accelerometer of the user device under a presumption that the user is facing forwards in line with a direction of travel, and wherein the subset of targeted advertisements are selected further responsive to the human-face direction-of-view information and a shape of the physical region of interest is adjusted based on the face direction-of-view information.

10. The method in accordance with claim 1, further comprising transmitting instructions for presenting a highlighted path in a map application, the highlighted path including a current user location and a store entrance corresponding to a currently presented advertisement from the subset of targeted advertisements.

11. The method in accordance with claim 1, further comprising generating, by the server, messages configured to be reproduced for the user that include indicia identifying the subset of targeted advertisements and an order of likely user proximity to the businesses within the geometric shape, wherein the messages are transmitted from the server to the user device through a message broker.

12. The method in accordance with claim 1, further comprising generating, by the server, messages configured to be reproduced for the user that include the subset of targeted advertisements in the order of likely user proximity to the businesses within the geometric shape.

13. The method in accordance with claim 1, further comprising:
generating, by the server, message data that includes the subset of targeted advertisements in the order of likely user proximity to the businesses within the geometric shape; and
transmitting the message data to a message broker.

14. The method in accordance with claim 1, further comprising generating, by an advertising partners backend system configured to communicate with the server, an advertising partners interface configured to manipulate advertisement data corresponding to the set of advertisements using various advertisement manipulation actions comprising advertisement deletion, advertisement addition, and advertisement adjustment.

15. The method in accordance with claim 1, further comprising maintaining an advertisement cost for an advertising partner responsive to each user click selecting a particular advertisement by users within a campaign period.

16. The method in accordance with claim 1, further comprising maintaining an advertisement cost for an advertising partner for a particular advertisement responsive to an adjustable number of views of the particular advertisement by users within a campaign period.

17. The method in accordance with claim 1, further comprising maintaining an advertisement cost for an advertising partner for a particular advertisement responsive to a subscription membership model wherein advertisers pay a recurring fee to access various degrees of advertising features, advertising analytics and enhanced user targeting options.

18. The method in accordance with claim 1, further comprising maintaining an advertisement cost for an advertising partner for a particular advertisement responsive to a performance-based revenue sharing model wherein revenue increases with increasing advertising campaign success measured in advertisement profit.

19. A system for location-based advertisement, comprising:
a receiver configured to receive location information and trajectory information of a user from a location determining device
one or more memories, individually or in combination, having instructions;
one or more processors each coupled to at least one of the one or more memories and configurable/operable to execute the instructions to:
generate a geometric shape representing a physical region of interest based on the location information and a user trajectory of the user based on the trajectory information, and
select a subset of targeted advertisements from a set of advertisements for display to the user responsive to (i) a present user context and (ii) the location information indicating the user trajectory will intersect the geometric shape representing the physical region of interest specified in the location information, the subset of targeted advertisements corresponding to businesses within at least a portion the geometric shape and based on the present user context; and
a transmitter configured to transmit the subset of targeted advertisements in an order of likely user proximity to the businesses within the geometric shape.
